(19) United States
(12) Patent Application Publication
(10) Pub. No.: US 2017/0208843 A1
(43) Pub. Date: Jul. 27, 2017

(54) COOKED FOOD PRODUCTS AND METHODS FOR MAKING THE SAME

(71) Applicant: Perdue Foods LLC, Salisbury, MD (US)

(72) Inventor: William James Hopkins, III, Laurel (DE)

(21) Appl. No.: 15/004,273

(22) Filed: Jan. 22, 2016

(51) Int. Cl. A23L 13/50; A23L 7/109; A23P 20/10; A23L 5/10

(52) U.S. Cl. CPC A23L 13/57; A23L 5/11; A23L 7/109; A23P 20/10; A23V 2002/00

(57) ABSTRACT

A method for making a cooked food product comprises blending an uncooked protein source (e.g., chicken) and at least one dehydrated ingredient (e.g., pasta) to form a mixture, and cooking the mixture to form the cooked food product. The mixture is cooked under conditions that cause at least some of the water that is released from the protein source upon cooking to be absorbed into the dehydrated ingredients, so that the dehydrated ingredients become “hydrated” or softened, instead of all of the water being released from the mixture. The cooked food product may be in the form of a nugget and may include a breading composition coated on the exterior surface of the nugget. The absorption of water from the meat into the dehydrated ingredients inhibits moisture from seeping out through the breading, keeping the outer breaded layer relatively crisp.

### FIELD OF THE INVENTION

The present invention relates generally to a method for making a cooked food product, and more particularly to a method that comprises cooking a blend of at least one protein source, such as meat, and dehydrated ingredients.

### BACKGROUND OF THE INVENTION

Breaded meat products, such as chicken nuggets, are extremely popular among adults and children. One of the common drawbacks of breaded food products is that the outer layer of breading often becomes water-logged or soggy during or after the product is cooked. There remains a need for new cooking methods to provide new and improved cooked products.

### SUMMARY OF THE INVENTION

An embodiment of the present invention provides a method for making a cooked food product, wherein the method comprises blending an uncooked protein source (e.g., chicken) and at least one dehydrated ingredient (e.g., pasta) to form a mixture, and cooking the mixture to form the cooked food product. The uncooked protein source has a “loss-on-cooking moisture content” and the at least one dehydrated ingredient has an initial mixture moisture content, which is the moisture content of the mixture excluding the loss-on-cooking moisture content. The loss-on-cooking moisture content is the amount of moisture of the uncooked protein source which evolves as released water from the protein source upon cooking. The released water and the water of the initial mixture moisture content provide an amount of water sufficient to be absorbed by the at least one dehydrated ingredient, thereby hydrating the at least one dehydrated ingredient during cooking.

The cooked food product may include a breading composition coated on its exterior surface. The absorption of water from the protein source into the dehydrated ingredient inhibits moisture from seeping out through the breading, keeping the outer breading layer relatively crisp. Yield of the product is also improved by causing at least some of the released water from the protein source to be absorbed by the at least one dehydrated ingredient. Another embodiment of the present invention provides an assembly comprising a package and one or more cooked food products (e.g., frozen food products) enclosed within the package.

According to another embodiment of the invention, a method for making a cooked food product comprises: mixing an uncooked protein source having a loss-on-cooking moisture content, a brine solution, and at least one dehydrated ingredient to form a mixture having an initial mixture moisture content; forming the mixture into a plurality of nuggets; coating the plurality of nuggets with a pre-dust to form a plurality of pre-dusted nuggets; coating the plurality of pre-dusted nuggets with a batter to form a plurality of batter-coated nuggets; breading the plurality of batter-coated nuggets to form a plurality of breaded nuggets; frying the plurality of breaded nuggets to set the breading in place to provide a plurality of fried nuggets; and cooking the plurality of fried nuggets in an oven to provide the cooked food product, wherein the loss-on-cooking moisture content of the uncooked protein source provides released water from the protein source upon frying or cooking in an oven or both, wherein the released water and the water of the initial mixture moisture content provide an amount of water sufficient to be absorbed by the at least one dehydrated ingredient, thereby hydrating the at least one dehydrated ingredient.

### DETAILED DESCRIPTION OF THE INVENTION

Embodiments of the present invention provide methods for making a cooked food product. The method provides for the capture of water that is released from meat during the cooking process (i.e., the loss-on-cooking moisture content of the meat or other protein source), whereby at least some of the water becomes absorbed into the food product. More specifically, water that is released from meat becomes absorbed into at least one dehydrated ingredient that has been combined with the meat, thereby softening the dehydrated ingredient, so that at least some of the moisture that is normally released as steam or free moisture becomes soaked into, or “tied up in,” the food product. In embodiments in which the food product has been coated with breading, the absorption of water from the meat into the dehydrated ingredient inhibits moisture from seeping out through the breading, keeping the outer layer of breading relatively crisp. Utilizing the released water in the food product also improves yield and improves the texture/eating quality of the product.

According to an embodiment of the invention, a method for making a cooked food product comprises blending an uncooked protein source with one or more dehydrated ingredients to form a mixture. The uncooked protein source may comprise raw meat (preferably raw ground meat), and raw meat is preferably entirely uncooked; however, it is possible for the meat to be heated for a very brief period of time and still be considered an uncooked protein source (i.e., it has been exposed to heat but it has not become fully cooked). The raw meat is preferably ground so that it can be thoroughly mixed with the dehydrated ingredient(s) and other ingredients.

Non-limiting examples of the types of meat that are suitable for use in accordance with the present invention include poultry (e.g., chicken and/or turkey), beef, pork and a combination thereof. Other types of uncooked protein sources may be used, such as tofu. According to a preferred embodiment, the meat is chicken meat, such as chicken breast meat or chicken rib meat. The uncooked protein source of the present invention has a loss-on-cooking moisture content, which refers to the amount of moisture which evolves from the meat itself during the cooking process as released water. This moisture content is typically pre-determined by the type of meat used and how it is processed, and will vary depending on the cooking conditions in a known way and in a way which can be readily empirically determined. Some of the effects of the invention, namely utilizing most or all of the moisture that is evolved from the meat during cooking to be absorbed by the dehydrated ingredient(s) and thereby limiting the undesirable moistening of any breading on the food product, are typically achieved by altering other variables, such as the ratio of meat to dehydrated ingredients.

The dehydrated ingredient(s) that are blended with the raw meat are initially dehydrated, which means that they are dehydrated when they are blended with the meat, but they become hydrated (i.e., their moisture content increases) during the mixing and cooking process, as the food product is heated. The hydration process may begin upon mixing of the dehydrated ingredients with the meat and/or a brine solution. Even if some hydration occurs during the mixing step, the dehydrated ingredients are still dehydrated to some extent prior to cooking (i.e., they have at least some capacity to absorb some water upon cooking). The types of dehydrated ingredients suitable for use in accordance with the present invention are not particularly limited. According to particular embodiments, the dehydrated ingredients are selected from the group consisting of pasta (e.g., macaroni), vegetables, beans, rice, grains, a dehydrated protein source, and a combination thereof. In one embodiment, the at least one dehydrated ingredient comprises pasta and a dehydrated protein source, such as dehydrated bacon.

As is well-known, typical edible dehydrated ingredients have some water activity, but the water activity of the dehydrated ingredients may vary over a wide range. The dehydrated ingredients used in the present invention may have an initial moisture content (prior to being combined with the meat, optional brine solution, and subsequently cooked) of close to 0% or indeed 0%. (All percentages mentioned herein are weight percentages unless otherwise noted.) The dehydrated ingredients used according to the present invention have at least some capacity to absorb water upon cooking without losing their form or shape. During the cooking process, the water activity and moisture content of the dehydrated ingredient(s) increases as the moisture evolved by the meat is absorbed.

A way to view the preferred relative amounts of ingredients to be utilized is to identify the saturation point of the dehydrated ingredients. In particular, the loss-on-cooking moisture content of the uncooked protein source and the initial moisture content of the mixture (with or without a brine solution) may be selected to achieve the purposes of the invention. This can be done by selecting the amounts of these two variables such that the amount of water provided by the released water and the water of the initial mixture moisture content (which by definition excludes the loss-on-cooking moisture content of the uncooked protein source) is sufficient to hydrate the at least one dehydrated ingredient to at least about 65% of its saturation point. A dehydrated ingredient's saturation point is the point at which it has fully absorbed water such that upon exposure to additional water, no further absorption of water occurs without altering its form and shape; for example, a single piece of macaroni would reach its saturation point when it expands in size due to water absorption to its fullest extent but before it begins to unravel and break up into multiple pieces or lose its general shape. The saturation point of a dehydrated ingredient depends primarily on its state of cooking and, to a lesser extent, its temperature. As used herein, the saturation point of the dehydrated ingredient is determined in its cooked state at room temperature.

In some embodiments, the amount of water provided by the released water and the water of the initial mixture moisture content is sufficient to hydrate the at least one dehydrated ingredient to at least about 65% and no more than about 105% of its saturation point. In other embodiments, the amount of water provided by the released water and the water of the initial mixture moisture content is sufficient to hydrate the at least one dehydrated ingredient to at least about 85% and no more than about 103% of its saturation point. In other embodiments, the amount of water provided by the released water and the water of the initial mixture moisture content is sufficient to hydrate the at least one dehydrated ingredient to at least about 99% and no more than about 101% of its saturation point. The extent of water absorption of the dehydrated ingredients can be controlled by selection of ingredients, varying the ratio of the protein source and the dehydrated ingredients, varying the loss-on-cooking moisture content and the mixture's initial moisture content, and changing the cooking conditions utilized. The desired water absorption will depend on the desired use of the product. For example, for firm products, less water absorption should be attained. In one embodiment, a water absorption of about 50%, or about 45 to 65% is attained. Food products having such a water absorption are used when a firm product is sought or could be used as a meat additive for soup, the heating of which by the end user or food service provider would cause further absorption. On the other hand, food products with dehydrated ingredients having much higher water absorption (e.g., 99%) are much softer and might appeal to children.

As mentioned above, the uncooked protein source and the at least one dehydrated ingredient may also be blended with a brine solution, which forms part of the mixture. In embodiments in which a brine solution is used, the moisture of the brine solution contributes to the initial mixture moisture content of the mixture. According to an embodiment, the brine solution comprises water and salt, and optionally yeast and/or flavoring agents. The meat, dehydrated ingredient(s) and brine solution may also be blended with cheese, which forms part of the mixture. The mixture may also include one or more additives commonly used in food products. Non-limiting examples of such additives are selected from the group consisting of coloring agents (e.g., apo-carotenal), flavoring agents (e.g., sugar, salt, onion powder, garlic powder, paprika, etc.), preservatives (e.g., sorbic acid, natamycin, etc.), thickening agents (e.g., guar gum) and a combination thereof.

In order to make a food product according to an embodiment of the present invention, the ingredients of the mixture (e.g., the meat, dehydrated ingredient(s), and optional brine solution, cheese and other optional additives) are blended until they are homogenously mixed. The blended mixture may be separated into individual portions, and the individual portions may be formed or molded, prior to being cooked; for example, the mixture may be shaped into individual spheres or triangular shapes, such as wedges. According to one embodiment, the mixture is molded into the form of a “nugget,” i.e., a formed unit of the mixture having a size similar to that of conventional chicken nuggets, which can be eaten as finger food. Each individual portion of the mixture may be referred to herein as a “food product.” The mixing process may be done in any conventional way, such as mixing a brine solution with the protein source and dried ingredient(s) in a hopper and then transferring each batch to a blender, where the mixture may be exposed to a vacuum and then blended. Preferably, the mixture is chilled to about room temperature before it is formed.

According to an embodiment, the blended mixture (or individual “food product”) is coated with a breading composition to form a breaded mixture, prior to being cooked. For example, the blended mixture may be coated sequentially in a pre-dust, batter and breading in a conventional manner. According to one embodiment, the pre-dust, batter and breading comprises wheat and/or corn flour, water, and corn starch. The breading composition may also include yeast and one or more optional additives, such as coloring agents, flavoring agents, preservatives, thickening agents and combinations thereof.

As used herein, “cooking” the mixture refers to heating the mixture by at least one of any cooking methods typical in the industry, such as heating in an oven or frying, among others. According to particular embodiments, cooking the mixture comprises heating the mixture in an oven, optionally preceded by and/or followed by a frying step. The mixture is heated under conditions that are sufficient to cause at least some of the water that is released from the protein source to be absorbed into the dehydrated ingredient(s), so that the dehydrated ingredient(s) become further “hydrated” or softened, instead of all of the water being released from the meat, for example as free moisture or steam. The cooking conditions (e.g., temperature, moisture content, etc.) may vary widely, depending on the particular combination of ingredients, and the size of the food product, among other factors. The moisture content also has a bearing on the wetness of the breading and may be adjusted in a known manner to achieve the desired mouth feel of the finished food product.

According to particular embodiments, “cooking” the mixture comprises frying the mixture in oil (e.g., soybean oil or another known cooking oil), and subsequently cooking the mixture in an oven. Preferably, the step of frying comprises “par-frying” the mixture, i.e., frying the mixture until it is only partially cooked in order to set the breading in place on the food product. According to one embodiment, the fryer is set to a temperature between about 340° F. and about 425° F., or between about 385° F. and about 395° F., and the mixture is fried for less than two minutes, preferably less than one minute (e.g., between about 15 seconds and about 45 seconds, or about 30 seconds).

According to another embodiment, the mixture is subsequently cooked in an oven until it achieves an internal temperature that is between about 150° F. and about 250° F., or between about 160° F. and about 250° F., or between about 150° F. and about 225° F., or between about 160° F. and about 225° F., or between about 150° F. and about 200° F., or between about 160° F. and about 200° F., or between about 161° F. and about 200° F. According to preferred embodiments, the mixture is cooked in the oven until it achieves a minimum internal temperature that is about 150° F., or about 160° F., or about 165° F., or about 170° F., or about 175° F. In order to achieve the aforementioned internal temperatures, oven settings may vary widely, and will depend on the size of each food product among other factors. According to one embodiment, the oven is set to between about 325° F. and about 375° F., or between about 335° F. and about 365° F., or between about 345° F. and about 355° F. (e.g., about 350° F.) at a dew point that is between about 125° F. and about 165° F., or between about 135° F. and about 155° F. (e.g., about 145° F.). The amount of time that the mixture cooks in the oven depends upon the size of the mixture; for example, a mixture that is between about 15 grams and about 20 grams may cook for between about 5 minutes and about 10 minutes at the aforementioned temperatures and dew points.

During the cooking process, the uncooked protein source releases water, and at least some of the water that is released from the meat becomes absorbed into the dehydrated ingredient(s), so that the dehydrated ingredient(s) become further “hydrated” or softened, instead of all of the water being released from the meat as free moisture or steam. The absorption of water from the meat inhibits moisture from seeping out from the meat block or through the breading (if present) , keeping the outer layer of the product as crisp as practical, recognizing that the product may be cooked in a moist oven. This also serves to improve yield and the flavor of the food product. The amount of brine solution and meat relative to the dehydrated ingredients may be optimized to achieve an appropriate ratio of moisture to dehydrated ingredients as the mixture is being cooked. This will vary over a wide range depending on the type and initial moisture contents of the uncooked protein source and dehydrated ingredient, whether a brine solution is used, and the conditions of cooking. Desirable weight ratios can be determined empirically, such as by varying the weight ratio over a range and testing the final product for desirable characteristics (e.g., moisture of nugget, crispiness of breading, mouth feel of cooked food product, and seepage of moisture from the food product during cooking) while keeping constant all other variables, including the types of meat and dehydrated ingredient; the initial hydration level of the dehydrated ingredient; the presence and type of brine solution; and the cooking conditions, including the cooking steps, time, temperature, and environmental moisture during any oven-cooking step.

Embodiments of the present invention provide a cooked food product made in accordance with any of the methods described herein. According to an exemplary embodiment, the cooked food product comprises chicken, pasta (as the ingredient that is initially dehydrated) and cheese, preferably shaped into a triangular or wedge shape. According to one embodiment, the cooked food product comprises: chicken meat (e.g., chicken breast meat), water, cheese (e.g., cheddar cheese), semolina (wheat), and optionally one or more additives (e.g., selected from the group consisting of coloring agents, flavoring agents, preservatives, thickening agents and a combination thereof), and a breading composition coated on the exterior of the food product. The breading composition may comprise wheat flour, water, corn flour, corn starch, yeast and optionally one or more additives (e.g., selected from the group consisting of coloring agents, flavoring agents, preservatives, thickening agents and a combination thereof).

According to particular embodiments, the method further comprises freezing the cooked food product, thereby forming a frozen food product. The food product may also be formulated to be shelf stable or stable in a refrigerator. Embodiments of the present invention also provide a package (e.g., a bag or box) containing the cooked food product (e.g., the frozen food product). Stated another way, an assembly comprises a package and one or more food products enclosed within the package. Preferably, a plurality of food products (e.g., frozen food products) are enclosed within the package. In another embodiment of the invention, the cooking step comprises a first cooking stage in which the food product is partially cooked (e.g., par-frying), and then the product is packaged and optionally frozen or refrigerated. Then, after some time has passed, possibly for shipping and storage, an end user or food service provider carries out a second cooking stage to completely cook the food product, for example by deep-frying or cooking in an oven. In this embodiment, the relative ratios are adjusted such that the desired water absorption of the dehydrated ingredient is attained after the second cooking stage.

Although the present invention has been described in connection with specific embodiments, it should be understood that the invention as claimed should not be unduly limited to such specific embodiments. Indeed, various modifications and variations of the described compositions and methods of the invention will be apparent to those of ordinary skill in the art and are intended to be within the scope of the appended claims.

What is claimed is:

1. A method for making a cooked food product, the method comprising:
mixing an uncooked protein source having a loss-on-cooking moisture content and at least one dehydrated ingredient to form a mixture having an initial mixture moisture content, and
cooking the mixture, thereby forming the cooked food product,
wherein the loss-on-cooking moisture content of the uncooked protein source decreases and provides released water from the protein source upon cooking, wherein the released water and the water of the initial mixture moisture content provide an amount of water sufficient to be absorbed by the at least one dehydrated ingredient, thereby hydrating the at least one dehydrated ingredient.

2. The method of claim 1, wherein the amount of water provided by the released water and the water of the initial mixture moisture content is sufficient to hydrate the at least one dehydrated ingredient to at least about 50% of its saturation point.

3. The method of claim 1, wherein the amount of water provided by the released water and the water of the initial mixture moisture content is sufficient to hydrate the at least one dehydrated ingredient to at least about 65% of the saturation point of the at least one dehydrated ingredient and is in an amount of no more than about 105% of the saturation point of the at least one dehydrated ingredient.

4. The method of claim 1, wherein the amount of water provided by the released water and the water of the initial mixture moisture content is sufficient to hydrate the at least one dehydrated ingredient to at least about 85% of the saturation point of the at least one dehydrated ingredient and no more than about 103% of the saturation point of the at least one dehydrated ingredient.

5. The method of claim 1, wherein the amount of water provided by the released water and the water of the initial mixture moisture content is sufficient to hydrate the at least one dehydrated ingredient to at least about 99% of the saturation point of the at least one dehydrated ingredient and no more than about 101% of the saturation point of the at least one dehydrated ingredient.

6. The method of claim 1, wherein the mixing step comprises mixing a brine solution along with the uncooked protein source and the at least one dehydrated ingredient to form the mixture.

7. The method of claim 1, wherein the uncooked protein source comprises uncooked meat.

8. The method of claim 7, wherein the uncooked meat is selected from the group consisting of poultry, beef, pork, and a combination thereof.

9. The method of claim 7, wherein the uncooked meat is poultry.

10. The method of claim 9, wherein the poultry is chicken.

11. The method of claim 1, wherein the mixing step comprises mixing a brine solution and cheese along with the uncooked protein source and the at least one dehydrated ingredient to form the mixture.

12. The method of claim 11, wherein the brine solution comprises water and salt.

13. The method of claim 1 further comprising forming the mixture into a plurality of individual portions and coating the plurality of individual portions with a breading composition to form a plurality of breaded individual portions, and subsequently cooking the plurality of breaded individual portions.

14. The method of claim 13, wherein cooking the plurality of breaded individual portions comprises frying the plurality of breaded individual portions in oil, and subsequently cooking the plurality of breaded individual portions in an oven.

15. The method of claim 14, wherein the step of cooking the plurality of breaded individual portions in the oven is done until the plurality of breaded individual portions achieves an internal temperature of between about 161° F. and about 200° F.

16. The method of claim 1, wherein the at least one dehydrated ingredient is selected from the group consisting of pasta, vegetables, beans, rice, grains, a dehydrated protein source, and a combination thereof.

17. The method of claim 1, where the at least one dehydrated ingredient comprises pasta and a dehydrated protein source.

18. A cooked food product made according to the method of claim 1.

19. The cooked food product of claim 18, wherein the protein source comprises chicken, the at least one dehydrated ingredient comprises pasta, and the food product further comprises cheese and a coating of breading.

20. The method of claim 1 further comprising freezing the cooked food product to form a frozen food product.

21. A frozen food product made according to the method of claim 20.

22. An assembly comprising:
a package; and
at least one frozen food product of claim 21 enclosed within the package.

23. The assembly according to claim 22 comprising a plurality of the frozen food products enclosed within the package.

24. The assembly according to claim 23, wherein the protein source comprises chicken, the at least one dehydrated ingredient comprises pasta, and the food product further comprises cheese and a coating of breading.

25. A method for making a cooked food product, the method comprising:
mixing an uncooked protein source having a loss-on-cooking moisture content, a brine solution, and at least one dehydrated ingredient to form a mixture having an initial mixture moisture content,
forming the mixture into a plurality of nuggets;
coating the plurality of nuggets with a pre-dust to form a plurality of pre-dusted nuggets;
coating the plurality of pre-dusted nuggets with a batter to form a plurality of batter-coated nuggets;
breading the plurality of batter-coated nuggets to form a plurality of breaded nuggets;
frying the plurality of breaded nuggets to set the breading in place to provide a plurality of fried nuggets; and
cooking the plurality of fried nuggets in an oven to provide the cooked food product, wherein the loss-on-cooking moisture content of the uncooked protein source decreases and provides released water from the protein source upon frying or cooking in the oven or both, wherein the released water and the water of the initial mixture moisture content provide an amount of water sufficient to be absorbed by the at least one dehydrated ingredient, thereby hydrating the at least one dehydrated ingredient.
